(19) United States
(12) Patent Application Publication
(10) Pub. No.: US 2011/0249452 A1
(43) Pub. Date: Oct. 13, 2011

(54) COMPOUND LIGHT CONDENSING APPARATUS

(76) Inventors: Yan-Zuo Chen, Taoyuan City (TW); Wen-Feng Cheng, Linkou Township (TW); Tzu-Heng Chen, Guishan Township (TW)

(21) Appl. No.: 12/757,393

(22) Filed: Apr. 9, 2010

(51) Int. Cl. F21V 5/02

(52) U.S. Cl. 362/339

(57) ABSTRACT

Provided is a compound light-condensing apparatus preferably including a lens body with refractive index n, and light-incident surface and light-ejected surface. The light-ejected surface has one set of Fresnel lens. When an incident light passes through the Fresnel lens structure, a focus with focal length F is formed. Two types of Fresnel lens structure are disposed on a light-ejected surface. More particularly, plural prism bodies are orderly disposed on the second type of Fresnel lens structure. The prism bodies counted from the central line is j and two adjacent prism bodies are spaced by p. The distance Tⱼ is from a base surface to light-ejected surface. An included angle αⱼ between ejected light and light-ejected surface is formed. By orderly changing the refractive angle of ejected light can be changed for achieving shorter focal length and better light condensation. The angle αⱼ is formulated as:

$${α}_{j} = \frac{1}{2} {cos}^{- 1} ( - \frac{1}{n} cos [ {tan}^{- 1} ( \frac{2 jp}{F - {T}_{j}} ) ] )$$

### BACKGROUND OF THE INVENTION

1. Field of the Invention

The present invention generally relates to a compound light condensing apparatus, more particularly to a compound light concentrating apparatus with a lens body having a refractive zone and a reflective zone thereon, in which it is to configure the thicknesses of prism bodies in reflective zone for altering the refractive angle of light, and to obtain shorter focal length and superior condensing effect.

2. Description of Related Art

Fresnel lens generally is a type of lens structure composed of concentric grooves, which are usually made by the transparent materials such as glass or plastics. Contrary to the traditional lens, Fresnel lens is made by much thinner lens capable of receiving more light, and the light can be projected to farther distance.

Reference is made to FIG. 1 showing a structural diagram of the conventional Fresnel lens. According to the structure, one side of a lens body 10 is formed by a plurality of orderly-arranged serrate blocks collectively as a Fresnel lens structure 101. The structure 101 is made with a whole block of transparent material. Alternatively, the structure 101 can be made by a plurality of individual prism bodies. The lower edge of each prism body is an inclined plane used to refract light. A fixed structure thickness T is distanced from a surface of the lens body 10 to the end of the inclined plane.

Since the Fresnel lens is featured with a shorter focal length and better light condensation, the lens can be used to condense the light beside to project the light. For example, the lens can be a solar collector for collecting the sunlight. FIG. 2 is referred to show a schematic diagram of condensing light of the conventional Fresnel lens. A light, which passes through the lens body 10, is refracted by a side of the Fresnel lens structure 101 and condensed on a focus 20. The focal length is F. The inclined plane of each prism body can effectively condense the light on a focus in a short distance. The Fresnel lens has superior effect of condensation.

### SUMMARY OF THE INVENTION

The structure of conventional Fresnel lens is applied to the present invention for providing a compound light condensing apparatus with shorter focal length and better light condensation. The lens body of the compound light condensing apparatus is generally divided into a refractive zone and a reflective zone. Altering thicknesses of the prism bodies in the reflective zone are used to refract the refractive angle of the incident light. The related parameters are calculated to define a shorter focal length and increase the effect of condensation.

The compound light condensing apparatus uses transparent material with a refractive index n for the lens body. The lens body includes a light-incident surface and a light-ejected surface. The light-ejected surface has at least one set of Fresnel lens. When an incidence of light enters the Fresnel lens structure, a focus with focal length F serves as the light focused on the central line. Particularly, a first set of Fresnel lens of the Fresnel lens structure is a refractive zone, and a second set of Fresnel lens in a reflective zone.

The first set of Fresnel lens is composed of a plurality of prism bodies orderly-arranged along a first base surface. Each prism body is counted by number i from the central line to inner. The first base surface and the light-ejected surface of the lens body are distance at a distance T. The two adjacent first prism bodies are distanced at a distance p. Further, a first angle αᵢ is formed between the first prism body and the extension of first base surface. The first angle is formulated as:

$${α}_{i} = {tan}^{- 1} ( \frac{sin [ {tan}^{- 1} ( \frac{2 ip}{F - T} ) ]}{cos [ {tan}^{- 1} ( \frac{2 ip}{F - T} ) ] - n} )$$

The second set of Fresnel lens is coupled with the first set of Fresnel lens. The second set of Fresnel lens also has a plurality of second prism bodies arranged in a sequential manner. Each prism body is counted by number j from the central line to outer. The two adjacent second prism bodies are distanced at a distance p. Regarding every second prism body, a second base surface is defined along a vertical direction of extension of the central line. This second base surface and the light-ejected surface of the lens body are distanced at a distance Tⱼ. This distance is a variable which is configured to form an outgoing light as an incident light passing through the second prism body. A second angle αⱼ is formed between the outgoing light and the light-ejected surface. The second angle is formulated as:

$${α}_{j} = \frac{1}{2} {cos}^{- 1} [ - \frac{1}{n} cos ( {tan}^{- 1} ( \frac{2 jp}{F - {T}_{j}} ) ) ]$$

Based on the mentioned variables, the design of the refraction zone and the reflection zone on the claimed compound light condensing apparatus can shorten the distance of light reaching the focus. It is effectively increase the light condensation.

Furthermore, in accordance with another embodiment, a serrate lens structure is formed on the light-incident surface of the lens body. The serrate lens structure alters an angle as the incident light entering the lens body, so as to shorten the focal length.

In order to further understand the characteristics and technical contents of the present invention, a description relating thereto will be made with reference to the accompanying drawings. However, the drawings are illustrative only but not used to limit the present invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the conventional Fresnel lens structure;

FIG. 2 is a schematic diagram of light condensation made by the conventional Fresnel lens;

FIG. 3 shows a top view of the compound light condensing apparatus in accordance with the present invention;

FIG. 4 shows a schematic diagram of a side view of the compound light condensing apparatus, and the paths presenting light condensation;

FIG. 5 shows curves of aspect ratios of the present invention and the conventional art;

FIG. 6 shows an angular relationship relating to the refraction zone of the compound light condensing apparatus in accordance with the present invention;

FIG. 7 shows an angular relationship relating to the reflection zone of the compound light condensing apparatus in accordance with the present invention;

FIG. 8 shows an angular relationship relating to the reflection zone between the compound light condensing apparatus in accordance with the present invention and the conventional art;

FIG. 9 illustrates a side view of the embodiment of the compound light condensing apparatus and the paths presenting light condensation;

FIG. 10 illustrates a side view of another embodiment of the compound light condensing apparatus and the paths presenting light condensation;

FIG. 11 shows a schematic diagram of the light path in accordance with the embodiment of the present invention;

FIG. 12 shows a curve chart presenting the aspect ratios of the compound light condensing apparatus in accordance with the present invention and the conventional art.

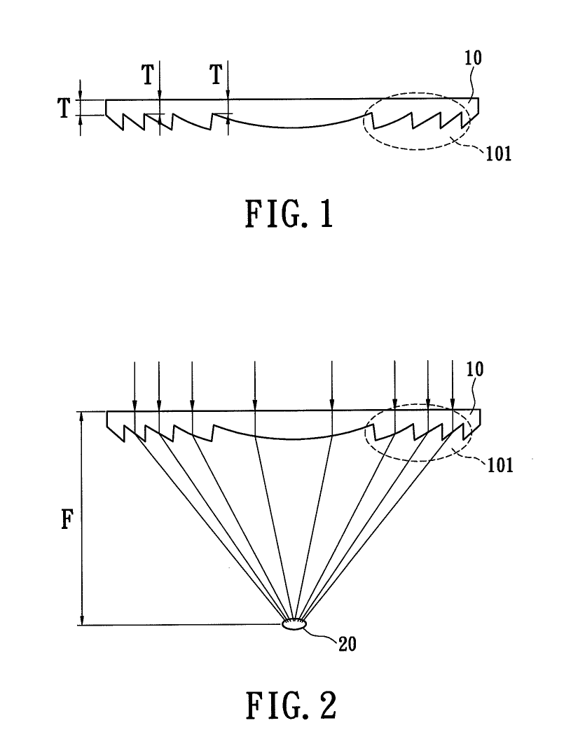

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

A compound light condensing apparatus is provided. The Fresnel lens structure is particularly featured to shorten the focal length and enhance light condensation through the optical design.

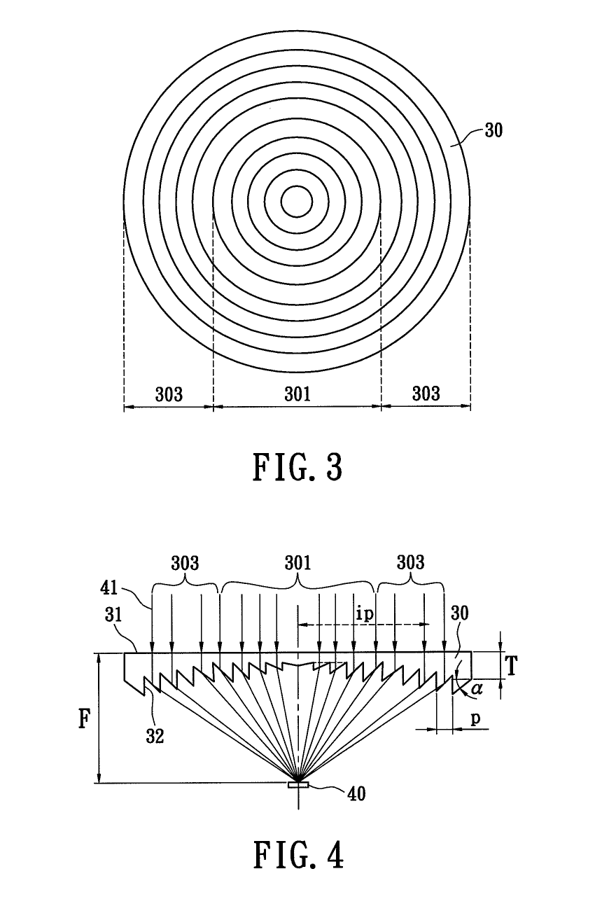

Reference is made to FIG. 3 illustrating a top view of the compound light condensing apparatus and also to the side view of the apparatus in FIG. 4 in accordance with the present invention. The compound light condensing apparatus shown in FIG. 3 is generally the structure of concentric grooves. The structure is a lens body 30 having a plurality of concentric grooves, which have a specific refractive index (n). Each circle of the concentric grooves specifically corresponds to one serrate prism body disposed on the lens body 30 of the compound light condensing apparatus. The structure of concentric serrate prism bodies further maps the top view of the embodiment of the compound light condensing apparatus shown in FIG. 4. In accordance with the current embodiment, two zones are respectively defined. The inner part of the Fresnel lens structure is a refraction zone 301 (the first set of Fresnel lens) having the prism bodies with the same thickness. The outer part of the structure of concentric grooves is a reflection zone 303 (the second set of Fresnel lens), on which the prism bodies have different thicknesses.

Such as FIG. 4, which shows the schematic diagram of the light path and the claimed compound light condensing apparatus. The compound light condensing apparatus includes a light-incident surface 31 and a light-ejected surface 32. In which, the light-ejected surface 32 includes the above-described two types of Fresnel lens structure. The lens structure is disposed on the same side of the lens. The apparatus has a thickness T. More particularly, the prism bodies with different thicknesses T serve as the reflection zone 303. The prism bodies are orderly counted by i from the inside out. The width of each prism body is p. Every prism body is distanced from the lens' center at a distance ip. The thickness T of every prism body in the reflection zone is getting increased outward, and the oblique angle (α) and its tangent value of each prism body is also changed correspondingly. The change of tan α is to alter the angle of reflected light, and the light (41) can be focused on a condensor 40. This design can effectively shorten the focal length F.

In accordance with the embodiment of the present invention, the first set of Fresnel lens in the refraction zone 301 has the same thickness T, such as the conventional Fresnel lens. The light (41) is first refracted and focused on the condensor 40 as it enters the serrate plane of the prism bodies. The thicknesses T of the second set of Fresnel lens in the reflection zone 303 are different, and forming the oblique angle α of each prism body. The light 41 is focused through a first reflection and a first refraction as it passes through the lens. After that, a total reflection is formed on the serrate oblique-plane with oblique angle α of each prism body. The reflected light is second refracted as it passes through the surface of one prism body. The light (41) is refracted and focused on the condensor 40 after the light is refracted by a surface.

Reference is made to a curve chart of aspect ratio related to the present invention and the conventional art. The horizontal axis of the chart is indicative of a value F#, which is defined by F#=(F−T)/2ip. The value F is focal length, T is thickness of lens, i means the index, and p is the width of prism body. Particularly, the value F# indicates the different focal length (F) by design, and is used to define the refraction zone and the reflection zone. In the current example, the refraction zone and the reflection zone are separately defined on a basis of F# being 0.5. F# is changeable based on the design.

Moreover, the vertical axis is the value of tangent of the oblique angle α (tan α), which is indicative of an aspect ratio of lens. The thickness T is changed in reference with F# in horizontal axis and the aspect ratio in vertical axis, thereby the better parameters can be obtained. Therefore, the Fresnel lens structure with lower aspect ratio or smaller F # can gather more light at a focal length.

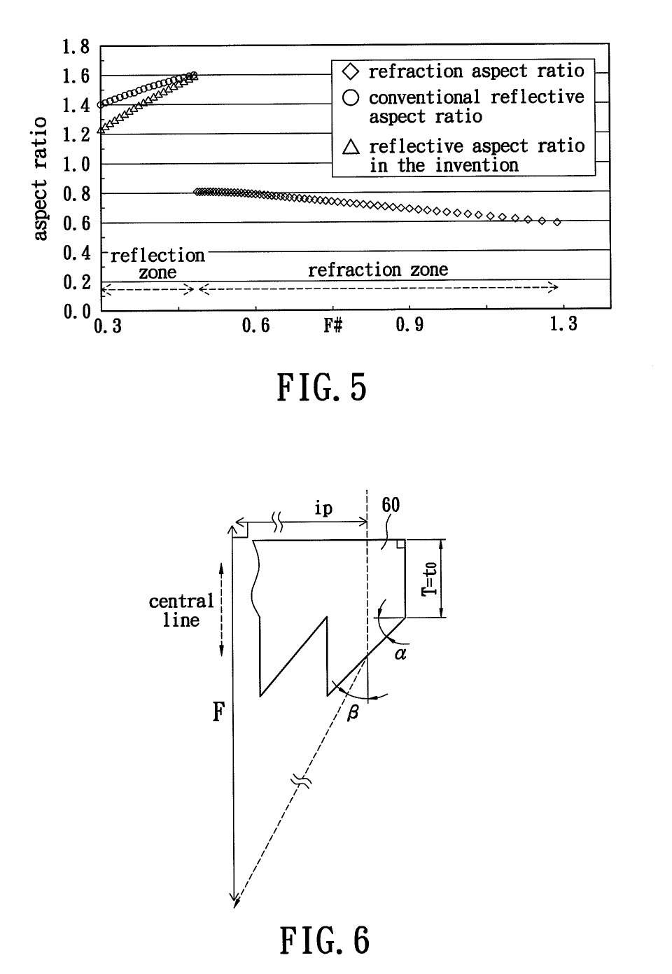

The reflection zone of the compound light condensing apparatus shown in FIG. 5 has lower aspect ratio than the ratio in the conventional art. More, the structure provided by the present invention make the tangent of oblique angle α smaller. The smaller angle α makes a smaller F #. So that, the compound light condensing apparatus in FIG. 4 can gather more light focused on the focus.

The angular relationship in the refraction zone of the compound light condensing apparatus is shown in FIG. 6. The figure shows a portion of prism body of the refraction zone. The focal length of the lens is F. A first base surface 60 is define along the horizontal direction of the first set of Fresnel lens in the refraction zone. A plurality of first prism bodies are formed along the first base surface 60. The first prism body is counted by i from the central line of the lens to the outer area. The upper edge of light-ejected surface of each prism body is distanced from the first base surface 60 at a fixed distance T, that is the thickness measured from the upper edge of the oblique structure to the light-incident surface. The thickness of every prism body in this zone is a fixed thickness t0. More, the two adjacent first prism bodies are distanced at a distance p. The distance distanced from every prism body to the center of the lens is ip.

In the exemplary example, the extension of the first prism body and the first base surface 60 forms the first angle (αᵢ). When the light enters the light-incident surface 31 and passes through the prism body, then the light is refracted by the oblique surface with the first angle (αᵢ). The light refracted by the oblique surface defines a light-outgoing angle β, which is an included angle between the incident light path and the refracted light path. The angles α and β are formulated as:

$$\begin{matrix}Wherein & \\ A = sin [ {tan}^{- 1} ( \frac{1}{2 F \#} ) ] & ( 5 ) \\ B = cos [ {tan}^{- 1} ( \frac{1}{2 F \#} ) ] - n & ( 6 )\end{matrix}$$

It is given

$$F \# = \frac{F - {t}_{0}}{2 ip} \qquad ( 3 )$$

It obtains

$$\begin{matrix}α = {tan}^{- 1} ( \frac{A}{B} ) \\ Wherein & ( 4 ) \\ A = sin [ {tan}^{- 1} ( \frac{1}{2 F \#} ) ] & ( 5 ) \\ B = cos [ {tan}^{- 1} ( \frac{1}{2 F \#} ) ] - n & ( 6 )\end{matrix}$$

The first angle (αᵢ) is fulfilled equation (7):

$${α}_{i} = {tan}^{- 1} ( \frac{sin [ {tan}^{- 1} ( \frac{2 ip}{F - T} ) ]}{cos [ {tan}^{- 1} ( \frac{2 ip}{F - T} ) ] - n} ) \qquad ( 7 )$$

According to the illustration of FIG. 6, the parameter F# defines the refraction zone 301 and the reflection zone 303 of Fresnel lens structure. For example, the refraction zone 301 is defined as F# is greater or equal to 0.5. The thickness between the light-ejected surface 32 of refraction zone 301 and the first base surface 60 is changeless. However, the thickness in the reflection zone 303 is changed.

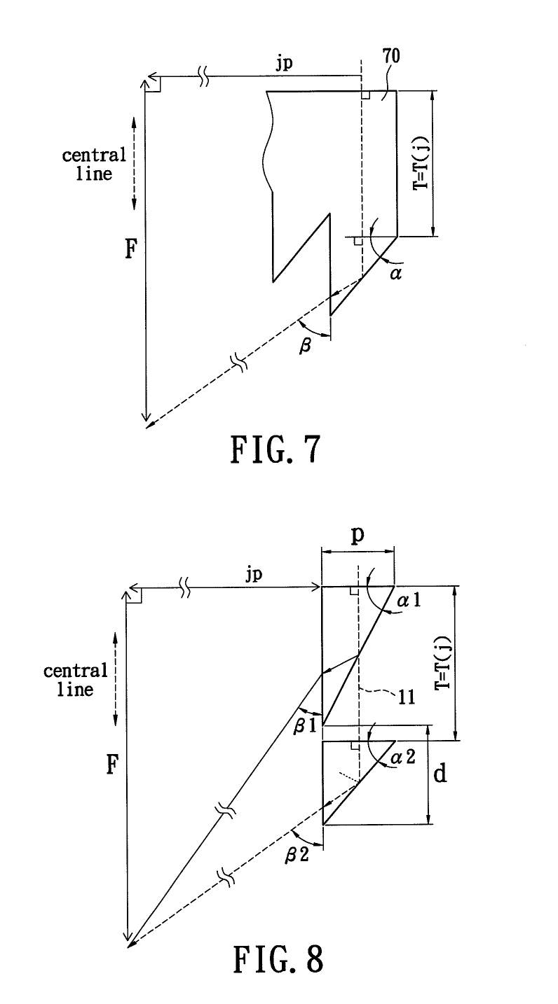

Reference is made to FIG. 7 showing a diagram which illustrates the angular relation in the reflection zone of the lens. The focal length of the lens is F. The second set of Fresnel lens in the reflection zone 303 is coupled with the first set of Fresnel lens. The second set of Fresnel lens is constituted by a plurality of orderly-arranged second prism bodies. A horizontal second base surface 70 is defined by each prism body and a vertical direction of the extension along the central line. The every prism body is counted from the central line to the peripheral. The second prism body in the reflection zone is counted by j which is distinct from the index i for numbering the prism body in refraction zone. The two adjacent second prism bodies are distanced at a distance p, that is the width of each prism body. The second base surface 70 and the upper edge of the light-ejected surface 32 of the second prism body are distanced at a distance T=Tj, that is the thickness from the upper edge of the inclined plane of light-ejected surface to the light-incident surface. A second angle (αⱼ) is the angle between the inclined plane of the light-ejected surface 32 of the second prism body and the second base surface 70, that is the oblique angle of the prism body.

The incident light is first totally-reflected using the second angle αⱼ by the inclined plane of the light-ejected surface of the second prism body as the light enters the lens. The reflected light is then refracted by one side of the second prism body. A light-outgoing angle β is defined between the refracted path and the direction of the vertical incident light (along the central line). The angles α and β are formulated as:

$$\begin{matrix}β = 90 - {sin}^{- 1} [ n sin ( 2 α - 90 ) ] & ( 8 ) \\ tan β = \frac{jp}{F - {T}_{j}} & ( 9 )\end{matrix}$$

It is given

$$F \# = \frac{F - {T}_{j}}{2 jp} \qquad ( 10 )$$

The second angle αⱼ fulfills equation (11):

$${α}_{j} = \frac{1}{2} {cos}^{- 1} [ - \frac{1}{2} cos ( {tan}^{- 1} ( \frac{2 jp}{F - {T}_{j}} ) ) ] \qquad ( 11 )$$

According to the above-described embodiment, the parameter F# is used to define the reflection zone. For example, the reflection zone is defined as F# is smaller than 0.5.

In FIG. 7, the second base surface 70 and the upper edge of the light-ejected surface 32 of second prism body are distanced at a variable distance T. The second set of Fresnel lens in the reflection zone is constituted by a plurality of prism bodies with different thicknesses. This kind of structure makes better light condensation.

Reference is made to FIG. 8 illustrating the angular relationship of the reflection zone in the present invention and the conventional art. The diagram shows the angular relationship between the oblique angle α1 and light-outgoing angle β1 of the conventional prism body, and the oblique angle α2 and the light-outgoing angle β2 of the Fresnel lens structure in the reflection zone of the present invention. Meanwhile, an incident light 11 enters the lens 30. The above triangle shows the structure of prism body 30 having oblique angle α1 of the conventional lens. The incident light 11 is reflected and refracted at the other side as entering the lens, so as to form the light-outgoing angle β1. The below of the Fresnel lens structure of the present invention has the oblique angle α2 and thickness T(j). Meanwhile, the incident light 11 is totally reflected as entering the lens. The light is refracted at the other side of the Fresnel lens structure so as to form the light-outgoing angle β2. The difference of thickness of prism body between the conventional art and the present invention is value d. The difference of the aspect ratio of prism body is formulated as equation (12):

$$tan α1 - tan α 2 ≅ \vert \frac{T - d}{p} \vert = \frac{1}{p} [ \vert T - \frac{jp}{2} \vert \frac{1}{tan β 1} - \frac{1}{tan β 2} \vert \vert ] \qquad ( 12 )$$

In which, for example, each prism body is counted by j and the width for every prism body is p. The preferred prism body has smaller oblique angle α, smaller aspect ratio (tan α), greater light-outgoing angle β. Therefore, it is to have better light condensation and shorter focal length.

In order to achieve the shorter focal length and better light condensation of the claimed compound light condensing apparatus, in accordance with one further embodiment, the serrate lens structure is formed on the light-incident surface 31 of the lens body. Through the modification of the refractive angle of incident light, it benefits the Fresnel lens structure have more smaller oblique angle and aspect ratio, and shorter focal length.

Reference is made to FIG. 9 showing a side view of the claimed lens apparatus. The lens body 30 of compound light condensing apparatus can be divided as one light-incident surface 31 for receiving the light, and one light-ejected surface 32. The structure of Fresnel lens is disposed on the light-ejected surface 32 in order to achieve the effect of light condensation. The serrate lens of the embodiment is disposed on the light-incident surface 31 in order to alter the thickness (T) of the Fresnel lens structure, and the angle as the incident light enters the lens body 30.

In the figure, it is noted that the light-incident surface 31 of lens body 30 has serrate structure 90 with a thickness T. In reference with the top view of the lens, this serrate structure 90 is concentric grooves or the similar structure. The structure changes the angle of incident light, and inevitably affects the design of Fresnel lens structure on the light-ejected surface 32. Moreover, the refraction zone 301 is disposed on the light-incident surface 31 above of light-ejected surface 32, and no any serrate structure. However, the serrate structure is disposed on the reflection zone of the light-incident surface 31 above of the light-ejected surface 32. So that, the prism body of the Fresnel lens structure in the reflection zone 303 still makes total reflection. The focusing position (condensor 92) can be changed by modifying the oblique angle α for each prism body. It means the design makes a shorter focal length F.

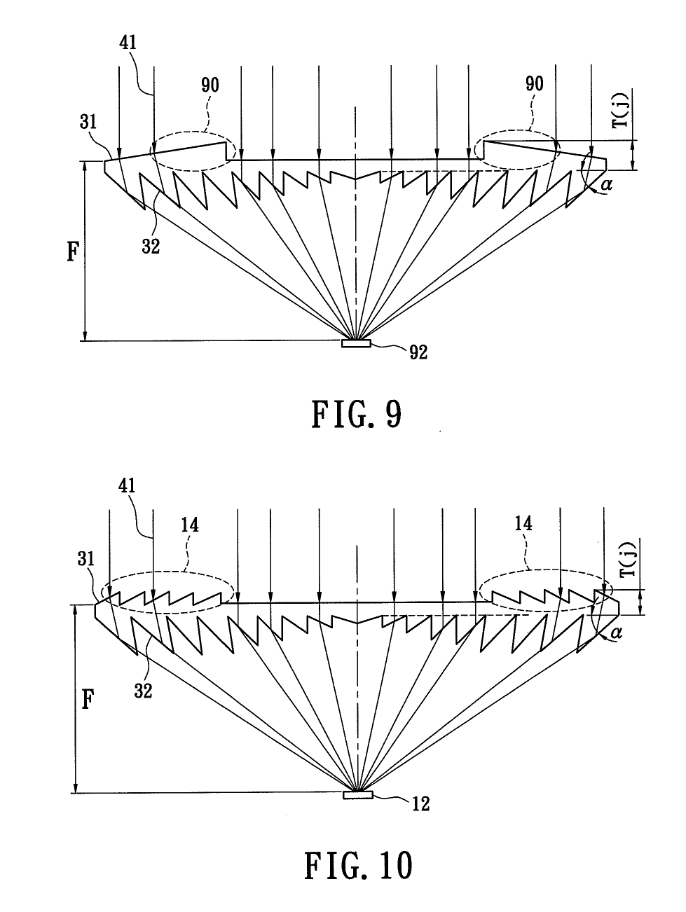

FIG. 10 shows a third embodiment. In which, a plurality of serrate lens structure 14 forms the light-incident surface 31 of the lens body 30. The structure 14 produces different types of light condensation, including shorter focal length and better focused position, such as on the position of condensor 12. Correspondingly, the each Fresnel lens body 30 on the light-ejected surface 32 needs to be modified, such as to modify the each oblique angle α of lens body 30.

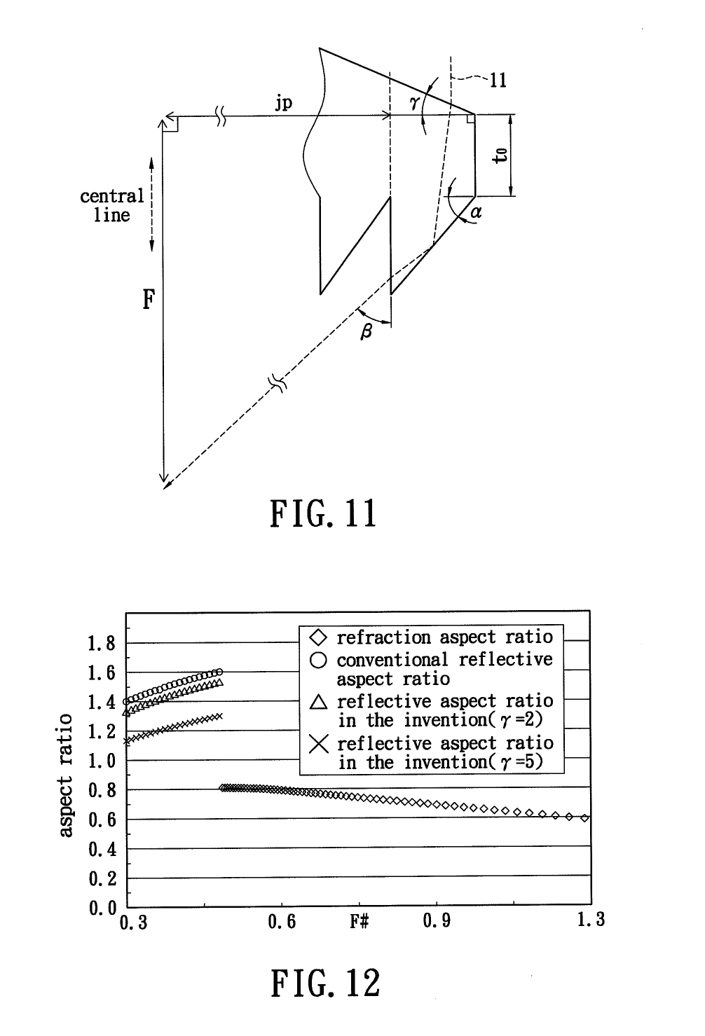

FIG. 11 shows the serrate lens structure formed above the lens body 30. The Fresnel lens body 30 has refractive index n. Each prism body is distanced from the central line at a distance jp and having focal length F. For example, the fixed thickness of lens body 30 is t₀. The light 11 vertically enters the serrate lens structure of the lens body 30. The light-incident surface 31 has an oblique angle γ. The light 11 is refracted and forming an incident angle as entering the Fresnel lens body 30. The entered light is totally reflected by the inclined plane of the lens body 30 on the light-ejected surface 32. The light is then refracted out by the Fresnel lens structure. After that, the light 11 is focused on a focus.

The oblique angle γ, the light-outgoing angle β, and the oblique angle α of the lens body of the mentioned serrate structure are formulated as equation (13):

$$β = 90 - {sin}^{- 1} ( n sin [ 2 ( α + γ - \frac{sin γ}{n} ) - 90 ] ) \qquad ( 13 )$$

It is given tan β=jp/(F−t0) ∘

The lens oblique angle αⱼ fulfills equation:

$${α}_{j} = \frac{1}{2} {cos}^{- 1} ( - \frac{1}{2} cos [ {tan}^{- 1} ( \frac{1}{2 F \#} ) ] ) - γ + \frac{sin γ}{n}$$

Wherein F#=(F−T₀)/2jp.

Accordingly, the serrate lens structure makes modification of the oblique angle αⱼ of prism body below the Fresnel lens body. In the meantime, the focal length is shorter since the light-outgoing angle β is also changed.

FIG. 12 shows a curve chart of aspect ratio between the second embodiment of the present invention and the conventional art. The horizontal axis of the chart represents the value F#, which is defined as F#=(F−T)/2jp. The vertical axis of the chart represents a tangent value of oblique angle α (tan α), which defines the aspect ratio. More, F is indicative of the focal length, T is for lens thickness, j indexes the prism body, and p is width of the prism body.

In reference with the relationship shown in FIG. 5, FIG. 12 shows the curve formed by the oblique angle γ of the serrate structure on the light-incident surface 31. It is featured that the serrate structure is disposed on the light-incident surface 31 in the reflection zone in the present invention. The curves are separately describing the conditions of the oblique angle γ=2° and γ=5°. No matter γ=2° or γ=5° for the serrate structure, the aspect ratios for the reflection zone 303 in the present invention are smaller than the value in the conventional Fresnel lens. Furthermore, the present invention can thereby design the structure having shortest focal length on a basis of the values of F# and aspect ratio. More light (more energy) can be focused on the focus since the light path is shorten.

To the summation of above description, the present invention relates to a type of the Fresnel lens structure. The lens provides a compound light condensing apparatus with a shorter focal length, much thinner, and better light condensation. The thickness of the Fresnel lens structure dominates the refractive angle of incident light.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A compound light condensing apparatus, comprising:
a lens body with a refractive index (n) and having a light-incident surface and a light-ejected surface, wherein the light-ejected surface has at least one set of Fresnel lens structure; wherein when an incident light is projected through the Fresnel lens structure, a focus is formed along a central line of the Fresnel lens structure and spaced out a focal length (F) apart from the light-ejected surface, wherein the set of Fresnel lens structure further comprises:
a first set of Fresnel lens having a plurality of orderly-arranged first prism bodies along a first base surface, and the first prism body with number (i) counted from the body at the central line, wherein the first base surface and an upper edge of the light-ejected surface are distanced at a fixed distance (T), and the two adjacent first prism bodies are distanced at a distance (p), and a first angle (αᵢ) is formed between the first prism body and an extension of the first base surface, the first angle is formulated as:
$${α}_{i} = {tan}^{- 1} ( \frac{sin [ {tan}^{- 1} ( \frac{2 ip}{F - T} ) ]}{cos [ {tan}^{- 1} ( \frac{2 ip}{F - T} ) ] - n} ) ;$$
a second set of Fresnel lens coupled with the first set of Fresnel lens, and the second set of Fresnel lens having a plurality of second prism bodies arranged in a sequential manner, wherein the second prism body with number (j) is counted from the body at the central line, and the two adjacent second prism bodies are distanced at a distance (p); a second base surface is defined as every second prism body along a vertical direction of extension of the central line, and the second base surface and the upper edge of the light-ejected surface are distanced at a distance (Tⱼ), and a second angle (αⱼ) is formed between the light-ejected surface of the second prism body and the extension of the second base surface, wherein the second angle is formulated as:
$${α}_{j} = \frac{1}{2} {cos}^{- 1} [ - \frac{1}{n} cos ( {tan}^{- 1} ( \frac{2 jp}{F - {T}_{j}} ) ) ] .$$

2. The apparatus of claim 1, wherein the first set of Fresnel lens serves as a refraction zone that is substantially the same in a thickness.

3. The apparatus of claim 2, wherein (F−T)/(2ip) in the first equation defines the refraction zone.

4. The apparatus of claim 3, wherein the first set of Fresnel lens with (F−T)/(2ip) greater than or equal to 0.5 is defined as the refraction zone.

5. The apparatus of claim 1, wherein the second set of Fresnel lens serves as a reflection zone with different thicknesses.

6. The apparatus of claim 5, wherein (F−Tⱼ)/(2jp) in the second equation is configured to define the reflection zone.

7. The apparatus of claim 6, wherein the second set of the Fresnel lens with (F−Tⱼ)/(2jp) smaller than 0.5 is defined as the reflection zone.

8. A compound light condensing apparatus, comprising:
a lens body with a refractive index (n), wherein the lens body has a light-incident surface and a light-ejected surface, and the light-ejected surface has at least one set of Fresnel lens; when an incident light is projected through the Fresnel lens structure, a focus is formed along a central line of the Fresnel lens structure, and the focus and the light-ejected surface are distanced at a focal length (F), wherein the Fresnel lens structure further comprises:
a first set of Fresnel lens having a plurality of first prism bodies orderly arranged along a first base surface, the first prism body with number (i) counted from the central line, wherein the first base surface and the upper edge of the light-ejected surface are distanced at a distance (T), and the two adjacent first prism bodies are distanced at a distance (p); a first angle (αᵢ) is formed between the first prism body and the extension of first base surface, and the first angle is formulated as:
$${α}_{i} = {tan}^{- 1} ( \frac{sin [ {tan}^{- 1} ( \frac{2 ip}{F - T} ) ]}{cos [ {tan}^{- 1} ( \frac{2 ip}{F - T} ) ] - n} ) ;$$
a second set of Fresnel lens, coupled with the first set of Fresnel lens, wherein the second set of Fresnel lens has a plurality of orderly-arranged second prism bodies, wherein the second prism body is counted by number (j) from the central line, and the two adjacent second prism bodies are are distanced at a distance (p); a second base surface is defined between a vertical direction of the extension of central line and every second prism body, and the second base surface and the upper edge of light-ejected surface are distanced at a distance (Tⱼ), and a second angle (αⱼ) is formed between the light-ejected surface of the second prism body and the extension of the second base surface, wherein the second angle is formulated as:
$${α}_{j} = \frac{1}{2} {cos}^{- 1} [ - \frac{1}{n} cos ( {tan}^{- 1} ( \frac{2 jp}{F - {T}_{j}} ) ) ] ;$$
and
a serrate lens disposed on the light-incident surface of the lens body, and used for altering the angle as the incident light entering the lens body.

9. The apparatus of claim 8, wherein the first set of Fresnel lens serves as the refraction zone that is substantially the same in a thicknesses.

10. The apparatus of claim 8, wherein (F−T)/(2ip) in the first equation is configured to define the refraction zone.

11. The apparatus of claim 10, wherein the first set of Fresnel lens with (F−T)/(2ip) greater and equal to 0.5 is defined as the refraction zone.

12. The apparatus of claim 8, wherein the second set of Fresnel lens serves as a reflection zone with different thicknesses.

13. The apparatus of claim 8, wherein (F−Tⱼ)/(2jp) in the second equation is configured to define the reflection zone.

14. The apparatus of claim 13, wherein the second set of Fresnel lens with (F−Tⱼ)/(2jp) smaller than 0.5 is defined as the reflection zone.

15. The apparatus of claim 8, wherein an oblique angle γ of the serrate lens is formulated as:
$${α}_{j} = \frac{1}{2} {cos}^{- 1} ( - \frac{1}{2} cos [ {tan}^{- 1} ( \frac{1}{2 F \#} ) ] ) - γ + \frac{sin γ}{n} ,$$
wherein F#=(F−Tⱼ)/2jp.

16. The apparatus of claim 15, wherein the serrate lens is formed as concentric grooves.
